(19) United States
(12) Patent Application Publication
(10) Pub. No.: US 2025/0264583 A1
(43) Pub. Date: Aug. 21, 2025

(54) RANGING DEVICE, RANGING METHOD, AND MOVABLE BODY

(71) Applicant: CANON KABUSHIKI KAISHA, Tokyo (JP)

(72) Inventor: SHOJI TANAKA, Tokyo (JP)

(21) Appl. No.: 19/044,836

(22) Filed: Feb. 4, 2025

(30) Foreign Application Priority Data
Feb. 15, 2024 (JP) 2024-021247

(51) Int. Cl. G01S 7/484; G01S 7/486; G01S 7/4861; G01S 7/4865; G01S 7/487; G01S 17/14; G01S 17/931

(52) U.S. Cl. CPC G01S 7/484; G01S 7/4861; G01S 7/4866; G01S 7/4868; G01S 7/4873; G01S 17/14; G01S 17/931

(57) ABSTRACT

A ranging device includes a light emission control unit configured to control a light emitting unit; a light receiving unit configured to detect reflected light and convert the reflected light into a pulse signal; an exposure period setting unit configured to set an exposure period for detecting the reflected light; and a frequency distribution generating unit configured to generate frequency distribution information. The light emission control unit controls a light emission interval of a pulse light. A plurality of light emission intervals include a first light emission interval and a second light emission interval having a length different from a length of the first light emission interval. At least one of the first light emission interval and the second light emission interval is shorter than a measurement period from when the pulse light is emitted to when the reflected light caused by the pulse light can be detected.

### BACKGROUND

### Field

The present disclosure relates to a ranging device, a ranging method, and a movable body.

### Description of the Related Art

Conventionally, a time of flight (TOF) method is known as one of methods for measuring a distance to an object by using light. In the TOF method, a distance to the object is measured based on a time from light emission toward the object to detection of reflected light from the object. Under an environment in which a plurality of similar ranging devices exist, a light emission interval of the ranging device itself and a light emission interval of the other ranging devices may be the same interval. In this case, there is a problem of interference between devices in that light emitted by another ranging device is erroneously recognized as reflected light from the object. In order to solve this problem, a laser radar device according to Japanese Patent Application Laid-Open No. 2019-158894 randomly sets a light projection timing of pulse light when the pulse light is projected from a light projection unit to the object in a distance measurement cycle.

### SUMMARY OF THE INVENTION

However, in the laser radar device according to Japanese Patent Application Laid-Open No. 2019-158894, when the light projection timing of the pulse light is set randomly, the light projection interval is widened from the shortest light projection interval, and thus frame rate may decrease.

It is an object of the present disclosure to provide a ranging device, a ranging method, and a movable body capable of suppressing interference with other ranging devices while suppressing a decrease in frame rate.

According to one disclosure of the present specification, there is provided a ranging device including: a light emission control unit configured to control a light emitting unit that emits a pulse light; a light receiving unit configured to detect reflected light emitted from the light emitting unit and reflected by an object in a measurement target region and convert the reflected light into a pulse signal; an exposure period setting unit configured to set an exposure period for detecting the reflected light; and a frequency distribution generating unit configured to generate frequency distribution information in which a count value obtained by counting the number of pulse signals and the exposure period are associated with each other, wherein the light emission control unit controls an light emission interval of the pulse light, wherein a plurality of light emission intervals include a first light emission interval and a second light emission interval having a length different from a length of the first light emission interval, wherein at least one of the first light emission interval and the second light emission interval is shorter than a measurement period from when the pulse light is emitted to when the reflected light caused by the pulse light can be detected.

According to one disclosure of the present specification, there is provided a ranging method including: controlling a light emitting unit that emits a pulse light; detecting reflected light emitted from the light emitting unit and reflected by an object in a measurement target region and converting the reflected light into a pulse signal, setting an exposure period for detecting the reflected light; and generating frequency distribution information in which a count value obtained by counting the number of pulse signals and the exposure period are associated with each other, wherein in the controlling, a light emission interval of the pulse light is controlled, wherein a plurality of light emission intervals include a first light emission interval and a second light emission interval having a length different from a length of the first light emission interval, and wherein at least one of the first light emission interval and the second light emission interval is shorter than a measurement period from when the pulse light is emitted to when the reflected light caused by the pulse light can be detected.

Further features of the present invention will become apparent from the following description of exemplary embodiments with reference to the attached drawings.

### BRIEF DESCRIPTION OF THE DRAWINGS

FIG. 1 is a hardware block diagram illustrating a configuration example of a ranging device according to a first embodiment.

FIG. 2 is a functional block diagram illustrating a configuration example of a light emitting device, a light receiving device, and a signal processing device according to the first embodiment.

FIG. 3 is a diagram illustrating a frame period, a sub-frame period, and a micro-frame period according to the first embodiment.

FIG. 4 is a timing chart illustrating a control example of a first exposure period and a light emission interval according to the first embodiment.

FIG. 5 is a histogram illustrating a relationship between the first exposure period and a count value of a pulse signal according to the first embodiment.

FIG. 6 is a timing chart illustrating a control example of a second exposure period and a light emission interval according to the first embodiment.

FIG. 7 is a histogram illustrating a relationship between the second exposure period and a count value of a pulse signal according to the first embodiment.

FIG. 8 is a timing chart illustrating a control example of a first exposure period and a light emission interval according to a second embodiment.

FIG. 9 is a histogram illustrating a relationship between the first exposure period and a count value of a pulse signal according to the second embodiment.

FIG. 10 is a histogram illustrating a relationship between a first exposure period and a count value of a pulse signal according to a comparative example of a third embodiment.

FIG. 11 is a timing chart illustrating a control example of the first exposure period and a light emission interval according to the third embodiment.

FIG. 12 is a histogram illustrating a relationship between a first exposure period and a count value of a pulse signal according to the third embodiment.

FIG. 13A and FIG. 13B are diagrams illustrating a configuration example of a movable body according to a fourth embodiment.

### DESCRIPTION OF THE EMBODIMENTS

### First Embodiment

A ranging device and a ranging method according to the first embodiment will be described. The ranging device described in the present embodiment uses a technique such as LiDAR (Light Detection And Ranging). The ranging device measures a distance from the ranging device to an object based on a time difference from when a light emitting device emits light toward a measurement target region to when a light receiving device receives reflected light from the object included in the measurement target region. In addition, the ranging device is a so-called time gate type device, switches an exposure period (gate period) according to a distance, and measures a distance to the object based on information of the exposure period in which the reflected light from the object is received.

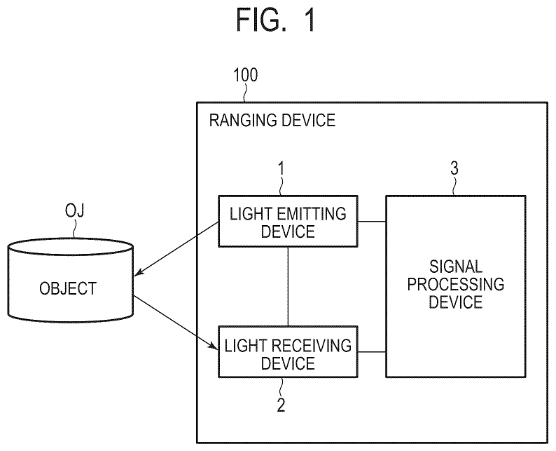

FIG. 1 is a hardware block diagram illustrating a configuration example of a ranging device 100. As illustrated in FIG. 1, the ranging device 100 includes a light emitting device 1, a light receiving device 2, and a signal processing device 3. The light emitting device 1, the light receiving device 2, and the signal processing device 3 are connected to each other.

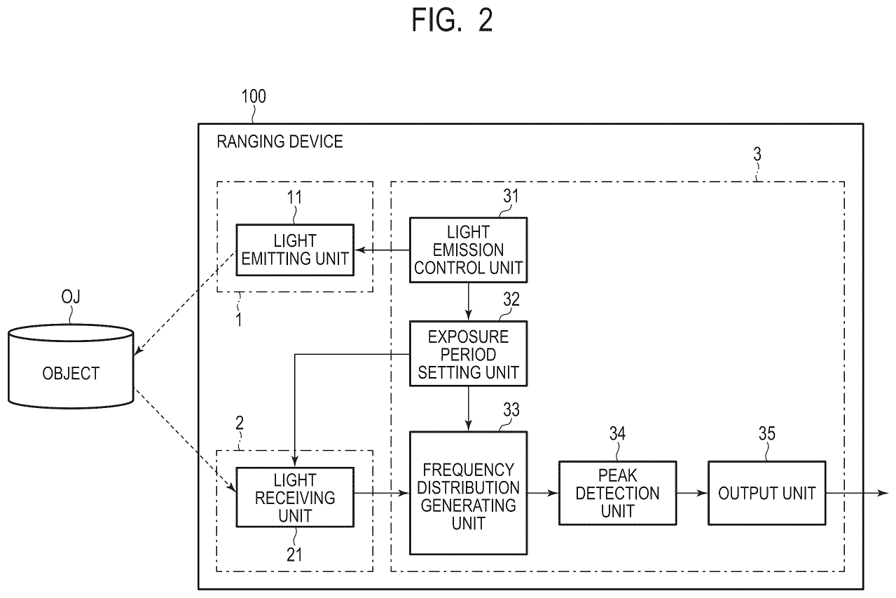

FIG. 2 is a functional block diagram illustrating a configuration example of the light emitting device 1, the light receiving device 2, and the signal processing device 3. The light emitting device 1 includes a light emitting unit 11 and emits light such as laser light. The light emitting unit 11 includes a light emitting element (not illustrated), and emits pulse light such as laser light emitted from the light emitting element toward the measurement target region including the object OJ. As the light emitting element constituting the light emitting unit 11, an element capable of high-speed modulation such as an LED (Light Emitting Diode) or an LD (Laser Diode) can be applied. The light emitting element may be a VCSEL (Vertical Cavity Surface Emitting Laser) or a surface light emitting element in which VCSELs are arranged in an array. It is desirable that the light emitting unit 11 is configured to emit light having a uniform amount of light to the measurement target region. The light emitting unit 11 may further include an optical element, for example, a lens, for optically converting the light emitted from the light emitting element and emitting the light to the measurement target region.

The light receiving device 2 includes a light receiving unit 21 and receives light. The light receiving unit 21 includes one or a plurality of light receiving elements (not illustrated), and receives light incident from the measurement target region. The light receiving elements constituting the light receiving unit 21 are arranged in a two-dimensional shape, for example, in a matrix shape, and measure distances at a plurality of points in the two-dimensional shape by receiving reflected light from the object OJ. As such a light receiving element, for example, a CMOS (Complementary Metal-Oxide-Semiconductor) sensor, a SPAD (Single Photon Avalanche Diode) sensor, or the like can be applied. In the case of the SPAD sensor, one pulse is generated in response to one photon entering an avalanche photodiode. The light incident on the light receiving unit 21 may include reflected light from the object OJ in the measurement target region and environmental light such as sunlight. The light receiving unit 21 detects an optical signal and converts the optical signal into a pulse signal (electric signal), and outputs the pulse signal to the signal processing device 3. The optical signal includes light emitted from the light emitting unit 11 and reflected by the object OJ in the measurement target region. The light receiving unit 21 may further include an optical element, such as a lens, for efficiently guiding the reflected light to the light receiving element.

The signal processing device 3 controls a light emission interval of light emitted from the light emitting device 1 and processes a pulse signal output from the light receiving device 2. The signal processing device 3 may include a processor that performs arithmetic processing of a digital signal, a memory that stores the digital signal, and the like. The signal processing device 3 may be, for example, an integrated circuit such as FPGA (Field-Programmable Gate Array) or an ISP (Image Signal Processor). The signal processing device 3 includes a light emission control unit 31, an exposure period setting unit 32, a frequency distribution generating unit 33, a peak detection unit 34, and an output unit 35. The light emission control unit 31 is connected to the light emitting unit 11 and the exposure period setting unit 32. The exposure period setting unit 32 is connected to the light receiving unit 21, the light emission control unit 31, and the frequency distribution generating unit 33. The frequency distribution generating unit 33 is connected to the light receiving unit 21, the exposure period setting unit 32, and the peak detection unit 34. The peak detection unit 34 is connected to the frequency distribution generating unit 33 and the output unit 35. The output unit 35 is connected to the peak detection unit 34 and an external device (not illustrated).

The light emission control unit 31 controls a light emission interval of the light emitting unit 11. The light emission control unit 31 outputs a light emission control signal for controlling a timing of light emission to the light emitting unit 11, and controls the light emission interval of the light emitted from the light emitting unit 11.

The exposure period setting unit 32 sets one of a plurality of exposure periods in the light receiving unit 21 for each emission of the pulse light by the light emitting unit 11. The exposure periods are determined according to a time from the emission of the light to the detection of the light. In the exposure period, a signal based on incident light is generated in the light receiving unit 21. The exposure period setting unit 32 generates an exposure control signal for controlling a timing of a start and end of the exposure period in the light receiving unit 21, and outputs the exposure control signal to the light receiving unit 21.

The frequency distribution generating unit 33 generates frequency distribution information. The frequency distribution generating unit 33 has a counter that counts pulse signals, and counts the number of pulse signals for each exposure period based on the exposure period information output from the exposure period setting unit 32 and the pulse signals output from the light receiving unit 21. The frequency distribution generating unit 33 generates frequency distribution information in which the count value obtained by counting the number of pulse signals and the exposure period are associated with each other. That is, the frequency distribution generating unit 33 generates the frequency distribution information in which the exposure period is a class, the count value of the pulse signal is a frequency, and the class and the frequency are associated. The frequency distribution generating unit 33 outputs the frequency distribution information to the peak detection unit 34.

The peak detection unit 34 detects the class having a maximum frequency (peak) from the frequency distribution information. The light incident on the light receiving unit 21 may include the reflected light from the object OJ and the environmental light such as sunlight. Therefore, the peak detection unit 34 detects the peak from the frequency distribution information and specifies the class (exposure period) corresponding to the frequency of the peak. The specified exposure period is time information corresponding to a flight time of light from when the light emitting unit 11 emits light toward the measurement target region to when the light receiving unit 21 receives the reflected light from the object OJ included in the measurement target region. The peak detection unit 34 outputs exposure period information indicating the specified exposure period to the output unit 35.

The output unit 35 outputs the exposure period information output from the peak detection unit 34 to an external device. The output unit 35 outputs the exposure period information to the external device, for example, every time one or a plurality of frame periods described later elapse.

The external device calculates a distance. The external device calculates the distance from the ranging device 100 to the object OJ based on the exposure period information output from the output unit 35.

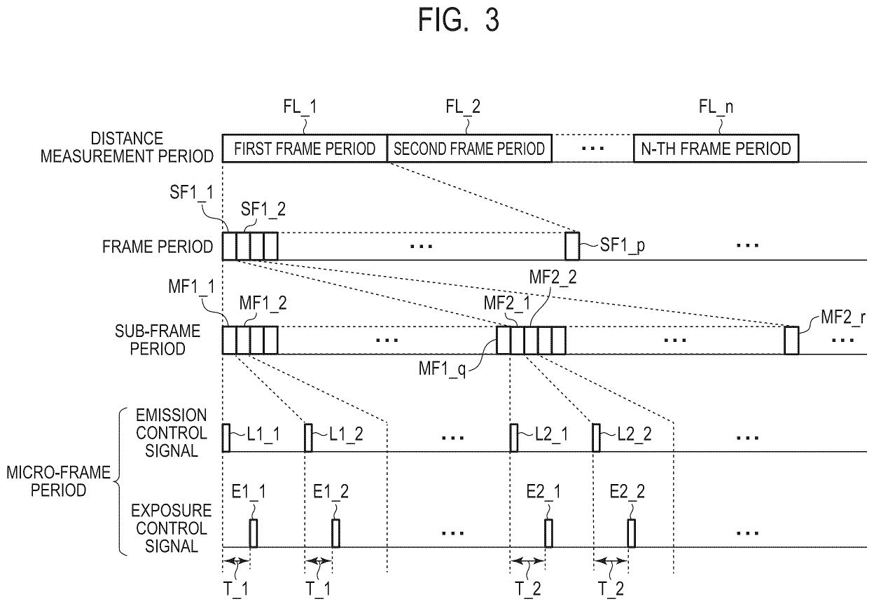

FIG. 3 is a diagram illustrating a frame period, a sub-frame period, and a micro-frame period according to the present embodiment. FIG. 3 illustrates a frame period in which exposure period information corresponding to one distance measurement result is acquired, a sub-frame period in which a sub-frame used to generate the exposure period information is acquired, and a micro-frame period in which a micro-frame used to generate the sub-frame is acquired. Each of these periods is schematically illustrated by arranging blocks in the horizontal direction. The horizontal direction in FIG. 3 indicates a time, and one block indicates one frame period, one sub-frame period, or one micro-frame period. FIG. 3 also illustrates a light emission control signal for controlling the light emission period of the light emitting unit 11 and an exposure control signal for controlling the exposure period of the light receiving unit 21.

In the “distance measurement period” of FIG. 3, a plurality of frame periods FL_1, FL_2, . . . , FL_n are illustrated. That is, the first frame period FL_1, the second frame period FL_2, and the n-th frame period FL_n are illustrated (n is an integer of 2 or more).

The one frame period includes a plurality of sub-frame periods. In the “frame period” of FIG. 3, a plurality of sub-frame periods SF1_1, SF1_2, . . . , SF1_p included in the first frame period FL_1 are illustrated. In other words, the first sub-frame period SF1_1, the second sub-frame period SF1_2, and the p-th sub-frame period SF1_p are illustrated. In the present embodiment, the number of sub-frame periods in the first frame period FL_1 is p (p is an integer of 2 or more).

The one sub-frame period includes a plurality of micro-frame periods. The micro-frame period is a period in which an emission of one pulse light by the light emitting unit 11 and a detection of an incident light in a predetermined exposure period by the light receiving unit 21 can be executed. By repeatedly providing the micro-frame periods, the reflected light can be received in each exposure period.

In the “sub-frame period” of FIG. 3, a plurality of micro-frame periods MF1_1, MF1_2, . . . , MF1_q included in the first sub-frame period SF1_1 are illustrated. That is, the first micro-frame period MF1_1, the second micro-frame period MF1_2, and the q-th micro-frame period MF_q are illustrated. In the present embodiment, the number of micro-frame periods in the first sub-frame period SF1_1 is q (q is an integer of 2 or more). The number q of the micro-frame periods corresponds to the number of times of integration of the light reception result.

Similarly, a plurality of micro-frame periods MF2_1, MF2_2, . . . , MF2_r included in the second sub-frame period SF1_2 are illustrated. That is, the first micro-frame period MF2_1, the second micro-frame period MF2_2, and the r-th micro-frame period MF_r are illustrated. In the present embodiment, the number of micro-frame periods in the second sub-frame period SF1_2 is assumed to be r (r is an integer of 2 or more). The number r of micro-frames corresponds to the number of times of integration of the light reception result.

The “light emission control signal” and the “exposure control signal” in FIG. 3 indicate a light emission control signal input to the light emitting unit 11 and an exposure control signal input to the light receiving unit 21 in the one micro-frame period. The light emitting unit 11 emits light during a period in which the light emission control signal output from the light emission control unit 31 is at a high level. The light receiving unit 21 detects incident light in the exposure period in which the exposure control signal output from the exposure period setting unit 32 is at a high level.

In the first micro-frame period MF1_1, the light emitting unit 11 emits light in the first light emission period L1_1, and the light receiving unit 21 receives light in the first exposure period E1_1. In the second micro-frame period MF1_2, the light emitting unit 11 emits light in the second light emission period L1_2, and the light receiving unit 21 receives light in the second exposure period E1_2. The light emitting unit 11 emits light at a light emission interval between the first light emission period L1_1 and the second light emission period L1_2. Since the first micro-frame period MF1_1 and the second micro-frame period MF1_2 are included in the same first sub-frame period SF1_1, the first exposure period E1_1 and the second exposure period E1_2 are set to the same timing from the light emission. That is, a length of the period T_1 from a start of the first light emission period L1_1 to a start of the first exposure period E1_1 is the same as a length of the period T_1 from a start of the second light emission period L1_2 to a start of the second exposure period E1_2. These periods T_1 correspond to a flight time of light from when the light emitting unit 11 emits light toward the measurement target region to when the light receiving unit 21 receives the reflected light from the object OJ included in the measurement target region.

Similarly, in the first micro-frame period MF2_1, the light emitting unit 11 emits light in the first light emission period L2_1, and the light receiving unit 21 receives light in the first exposure period E2_1. In the second micro-frame period MF2_2, the light emitting unit 11 emits light in the second light emission period L2_2, and the light receiving unit 21 receives light in the second exposure period E2_2. The light emitting unit 11 emits light at a light emission interval between the first light emission period L2_1 and the second light emission period L2_2. Since the first micro-frame period MF2_1 and the second micro-frame period MF2_2 are included in the same second sub-frame period SF1_2, the first exposure period E2_1 and the second exposure period E2_2 are set to the same timing from the light emission. That is, a length of the period T_2 from a start of the first light emission period L2_1 to a start of the first exposure period E2_1 is the same as a length of the period T_2 from a start of the second light emission period L2_2 to a start of the second exposure period E2_2. These periods T_2 correspond to the flight time of the light from when the light emitting unit 11 emits the light toward the measurement target region to when the light receiving unit 21 receives the reflected light from the object OJ included in the measurement target region. The sub-frame periods of the period T_1 and the period T_2 are different from each other, and thus the lengths of the period T_1 and the period T_2 are different from each other. The difference between the length of the period T_1 and the length of the period T_2 corresponds to a length of one exposure period. When one sub-frame period is shifted, a timing of outputting the exposure control signal is shifted by the length of one exposure period. However, the relationship between the sub-frame period and the timing of outputting the exposure control signal is not limited to this.

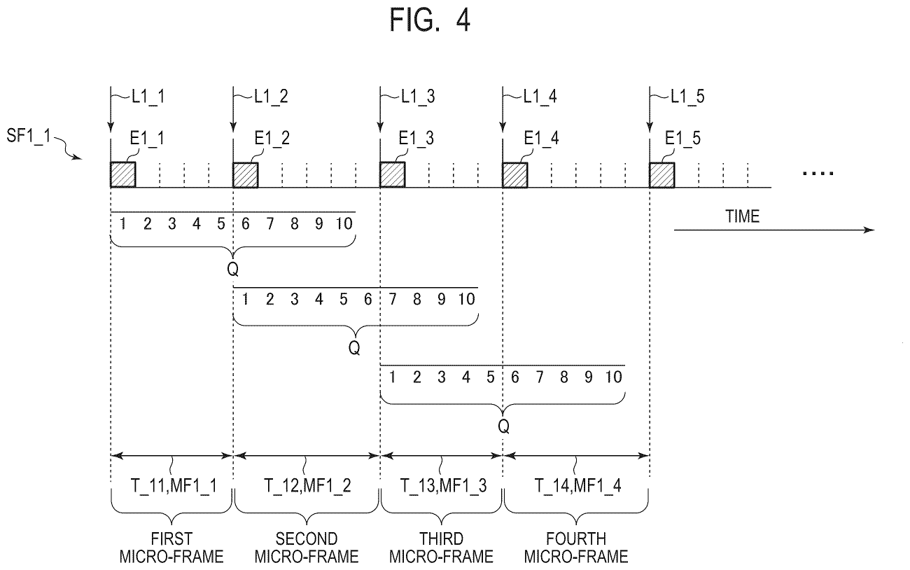

Next, an example of controlling the exposure period and the light emission interval will be described in detail. FIG. 4 is a timing chart illustrating a control example of a first exposure period and the light emission interval according to the present embodiment. A measurement period Q illustrated in FIG. 4 is a period from when pulse light is emitted to when reflected light caused by the pulse light can be detected. The measurement period Q is ensured to have a sufficiently length that does not affect other distance measurement results by weakening the reflected light caused by the pulse light. In the present embodiment, the measurement period Q is a period obtained by multiplying the exposure period by an integral multiple (e.g., 10 times). That is, the measurement period Q is a period corresponding to a length of ten exposure periods “1” to “10”. The exposure periods “1” to “10” illustrated in FIG. 4 indicate numerical values proportional to a distance from when the light emitting unit 11 emits light toward the measurement target region to when the light receiving unit 21 receives reflected light from the object OJ included in the measurement target region. The exposure periods “1” to “10” can also be numerical values proportional to the flight time of light such as the periods T_1 and T_2. In the exposure periods “1” to “10”, a distance to the object OJ can be measured based on a count value obtained by counting the number of pulse signals generated in accordance with the incidence of light in each exposure period. In the following description, the exposure periods “1” to “10” may be described as distances “1” to “10”.

In a predetermined sub-frame period, the exposure period setting unit 32 sets any one of exposure periods “1” to “10” (e.g., exposure period “1”) in each of a plurality of micro-frame periods. Thereafter, when the sub-frame period shifts to the next sub-frame period, the exposure period setting unit 32 switches to another exposure period (for example, the exposure period “2”) among the exposure periods “1” to “10”, and sets the switched exposure period “2” to each of the micro-frame periods. The exposure period setting unit 32 performs the same processing until all the exposure periods are set.

FIG. 4 illustrates an example in which the reflected light from the object OJ located at the distance “1” is received in the first exposure period. The first sub-frame period SF1_1 illustrated in FIG. 4 is a period in which the reflected light from the object OJ located at the distance “1” can be received. FIG. 4 illustrates light emission periods L1_1, L1_2, L1_3, L1_4, and L1_5, and exposure periods E1_1, E1_2, E1_3, E1_4, and E1_5. Further, micro-frame periods MF1_1, MF1_2, MF1_3, and MF1_4 are illustrated.

The light emission control unit 31 outputs a light emission control signal indicating that light is emitted in the first light emission period L1_1 to the light emitting unit 11 at a predetermined timing when power of the ranging device 100 is turned on or the like. The light emitting unit 11 emits light in the first light emission period L1_1 based on the light emission control signal. The light emission control unit 31 outputs a light emission notification indicating that the light emission control is performed in the first light emission period L1_1 to the exposure period setting unit 32.

The exposure period setting unit 32 determines a first exposure period E1_1 in the first micro-frame period MF1_1. The first exposure period E1_1 is a period in which the reflected light caused by the light emitted in the first light emission period L1_1 can be received. The first exposure period E1_1 is a period in which the reflected light from the object OJ at the distance “1” can be received. The exposure period setting unit 32 outputs an exposure control signal to the light receiving unit 21 at a start timing of the first exposure period E1_1 based on the light emission notification output from the light emission control unit 31. When the reflected light from the object OJ is incident in the first exposure period E1_1, the light receiving unit 21 converts the received light into a pulse signal of an electrical signal, and outputs the pulse signal to the frequency distribution generating unit 33. When the reflected light is not incident, the light receiving unit 21 does not output the pulse signal to the frequency distribution generating unit 33. The exposure period setting unit 32 outputs exposure period information indicating that the first exposure period E1_1 is set in the light receiving unit 21 to the frequency distribution generating unit 33.

The frequency distribution generating unit 33 counts the pulse signal based on the pulse signal output from the light receiving unit 21 and the exposure period information (first exposure period E1_1) output from the exposure period setting unit 32. The frequency distribution generating unit 33 generates and holds frequency distribution information in which the first exposure period E1_1 is a class and a count value obtained by counting the number of pulse signals is a frequency.

In the second micro-frame period MF1_2, the light emission control unit 31 outputs a light emission control signal indicating light emission in a second light emission period L1_2 to the light emitting unit 11. The second light emission period L1_2 is determined so that a light emission interval T_11 is shorter than the measurement period Q. The light emission interval T_11 is a length corresponding to five exposure periods. The light emitting unit 11 emits light in the second light emission period L1_2 based on the light emission control signal. The light emission control unit 31 outputs a light emission notification indicating that the light emission control is performed in the second light emission period L1_2 to the exposure period setting unit 32.

The exposure period setting unit 32 determines a second exposure period E1_2 in the second micro-frame period MF1_2. The second exposure period E1_2 is a period in which the reflected light caused by the light emitted in the second light emission period L1_2 can be received. The second exposure period E1_2 is a period in which the reflected light from the object OJ at the distance “1” can be received. The exposure period setting unit 32 outputs an exposure control signal to the light receiving unit 21 at a start timing of the second exposure period E1_2 based on the light emission notification output from the light emission control unit 31. When the reflected light from the object OJ is incident in the second exposure period E1_2, the light receiving unit 21 converts the received light into a pulse signal and outputs the pulse signal to the frequency distribution generating unit 33. The exposure period setting unit 32 outputs exposure period information indicating that the second exposure period E1_2 is set in the light receiving unit 21 to the frequency distribution generating unit 33.

The frequency distribution generating unit 33 counts the pulse signal based on the pulse signal output from the light receiving unit 21 and the exposure period information (the second exposure period E1_2) output from the exposure period setting unit 32. The frequency distribution generating unit 33 generates and holds frequency distribution information in which the second exposure period E1_2 is a class and a count value obtained by counting the number of pulse signals is a frequency.

In the third micro-frame period MF1_3, the light emission control unit 31 outputs a light emission control signal indicating light emission in a third light emission period L1_3 to the light emitting unit 11. The third light emission period L1_3 is determined such that a length of a light emission interval T_12 from the second light emission period L1_2 to the third light emission period L1_3 is shorter than the measurement period Q and different from the length of the light emission interval T_11. The third light emission period L1_3 is determined such that the length of the light emission interval T_12 is shorter than the measurement period Q by four exposure periods. That is, since the measurement period Q has the length corresponding to ten exposure periods, the light emission interval T_12 has the length corresponding to six exposure periods. As described above, the light emission interval T_12 has the length different from that of the light emission interval T_11 corresponding to five exposure periods. Specifically, the difference between the light emission interval T_11 and the light emission interval T_12 corresponds to an integral multiple (for example, one time) of the exposure period. That is, the light emission interval T_12 is longer than the light emission interval T_11 by one exposure period. The light emitting unit 11 emits light in the third light emission period L1_3 based on the light emission control signal. The light emission control unit 31 outputs a light emission notification indicating that the light emission control is performed in the third light emission period L1_3 to the exposure period setting unit 32.

The exposure period setting unit 32 determines a third exposure period E1_3 in the third micro-frame period MF1_3. The third exposure period E1_3 is a period in which the reflected light caused by the light emitted in the third light emission period L1_3 can be received. The third exposure period E1_3 is a period in which the reflected light from the object OJ at the distance “1” can be received. The exposure period setting unit 32 outputs an exposure control signal to the light receiving unit 21 at a start timing of the third exposure period E1_3 based on the light emission notification output from the light emission control unit 31. When the reflected light from the object OJ is incident in the third exposure period E1_3, the light receiving unit 21 converts the received light into a pulse signal and outputs the pulse signal to the frequency distribution generating unit 33. The exposure period setting unit 32 outputs exposure period information indicating that the third exposure period E1_3 is set in the light receiving unit 21 to the frequency distribution generating unit 33.

The frequency distribution generating unit 33 counts the pulse signal based on the pulse signal output from the light receiving unit 21 and the exposure period information (third exposure period E1_3) output from the exposure period setting unit 32. The frequency distribution generating unit 33 generates and holds frequency distribution information in which the third exposure period E1_3 is a class and a count value obtained by counting the number of pulse signals is a frequency.

In the fourth micro-frame period MF1_4, the light emission control unit 31 outputs a light emission control signal indicating light emission in a fourth light emission period L1_4 to the light emitting unit 11. The fourth light emission period L1_4 is determined such that a length of a light emission interval T_13 from the third light emission period L1_3 to the fourth light emission period L1_4 is shorter than the measurement period Q and different from the length of the light emission interval T_12. The fourth light emission period L1_4 is determined such that the length of the light emission interval T_13 is shorter than the measurement period Q by five exposure periods. That is, the light emission interval T_13 has the length corresponding to five exposure periods. The light emission interval T_13 is different from the length of the light emission interval T_12, but is the same as the length of the light emission interval T_11. The light emitting unit 11 emits light in the fourth light emission period L1_4 based on the light emission control signal output from the light emission control unit 31. The light emission control unit 31 outputs a light emission notification indicating that the light emission control is performed in the fourth light emission period L1_4 to the exposure period setting unit 32.

The exposure period setting unit 32 determines a fourth exposure period E1_4 in the fourth micro-frame period. The fourth exposure period E1_4 is a period in which the reflected light caused by the light emitted in the fourth light emission period L1_4 can be received. The fourth exposure period E1_4 is a period in which the reflected light from the object OJ at the distance “1” can be received. The exposure period setting unit 32 outputs an exposure control signal to the light receiving unit 21 at a start timing of the fourth exposure period E1_4 based on the light emission notification output from the light emission control unit 31. When the reflected light from the object OJ is incident in the fourth exposure period E1_4, the light receiving unit 21 converts the received light into a pulse signal and outputs the pulse signal to the frequency distribution generating unit 33. The exposure period setting unit 32 outputs exposure period information indicating that the fourth exposure period E1_4 is set in the light receiving unit 21 to the frequency distribution generating unit 33.

The frequency distribution generating unit 33 counts the pulse signal based on the pulse signal output from the light receiving unit 21 and the exposure period information (fourth exposure period E1_4) output from the exposure period setting unit 32. The frequency distribution generating unit 33 generates and holds frequency distribution information in which the fourth exposure period E1_4 is a class and a count value obtained by counting the number of pulse signals is a frequency.

In the fifth micro-frame period (not illustrated), the light emission control unit 31 outputs a light emission control signal indicating that light is emitted in a fifth light emission period L1_5 to the light emitting unit 11. The fifth light emission period L1_5 is determined such that a length of a light emission interval T_14 from the fourth light emission period L1_4 to the fifth light emission period L1_5 is shorter than the measurement period Q and different from the length of the light emission interval T_13. The fifth light emission period L1_5 is determined such that the length of the light emission interval T_14 is shorter than the measurement period Q by four exposure periods. That is, the light emission interval T_14 is a length corresponding to six exposure periods. The light emission interval T_14 is different from the lengths of the light emission intervals T_11 and T_13, but is the same as the length of the light emission interval T 12. In this manner, the light emission control unit 31 controls the light emission intervals so that a first light emission interval (light emission intervals T_11 and T_13) and a second light emission intervals (light emission intervals T_12 and T_14) having lengths different from the first light emission interval alternate with each other. In this way, the light emission control unit 31 periodically changes the light emission interval. The light emitting unit 11 emits light in the fifth light emission period L1_5 based on the light emission control signal output from the light emission control unit 31. The light emission control unit 31 outputs a light emission notification indicating that the light emission control is performed in the fifth light emission period L1_5 to the exposure period setting unit 32.

The exposure period setting unit 32 determines a fifth exposure period E1_5 in the fifth micro-frame period. The fifth exposure period E1_5 is a period in which the reflected light caused by the light emitted in the fifth light emission period L1_5 can be received. The fifth exposure period E1_5 is a period in which the reflected light from the object OJ at the distance “1” can be received. The exposure period setting unit 32 outputs an exposure control signal to the light receiving unit 21 at a start timing of the fifth exposure period E1_5 based on the light emission notification output from the light emission control unit 31. When the reflected light from the object OJ is incident in the fifth exposure period E1_5, the light receiving unit 21 converts the received light into a pulse signal and outputs the pulse signal to the frequency distribution generating unit 33. The exposure period setting unit 32 outputs exposure period information indicating that the fifth exposure period E1_5 is set in the light receiving unit 21 to the frequency distribution generating unit 33.

The frequency distribution generating unit 33 counts the pulse signal based on the pulse signal output from the light receiving unit 21 and the exposure period information (fifth exposure period E1_5) output from the exposure period setting unit 32. The frequency distribution generating unit 33 generates and holds frequency distribution information in which the fifth exposure period E1_5 is a class and a count value obtained by counting the number of pulse signals is a frequency.

By setting the light emission interval T_11 to be shorter than the measurement period Q, the second exposure period E1_2 can also receive reflected light from the object OJ at a distance “6” in the first micro-frame period MF1_1. Similarly, the third exposure period E1_3 can also receive reflected light from the object OJ at the distance “7” in the second micro-frame period MF1_2. The fourth exposure period E1_4 can also receive reflected light from the object OJ at a distance “6” in the third micro-frame period MF1_3. The fifth exposure period E1_5 can also receive reflected light from the object OJ at a distance “7” in the fourth micro-frame period MF1_4.

In the first sub-frame period SF1_1, following the above-described fifth micro-frame period, the same processing is repeated until the q-th micro-frame period MF1_q (q is an integer of 6 or more). As described above, in the first sub-frame period SF1_1, the micro-frame period is repeated q times, and the exposure period in which the reflected light from the object OJ at the distance “1” can be received is set a plurality of times (q times). Further, in the first sub-frame period SF1_1, the light emission intervals T_11, T_12, T_13, T_14, and the like are set to be shorter than the measurement period Q. As a result, the exposure period in which the reflected light from the object OJ at the distances “6” and “7” can be received is also set a plurality of times.

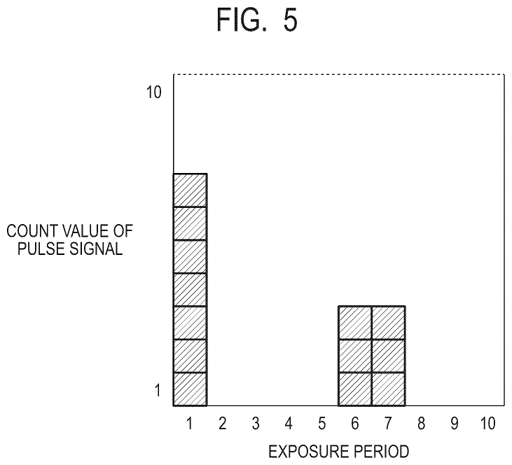

FIG. 5 is a frequency distribution illustrating a relationship between a first exposure period and a count value of a pulse signal. For convenience of explanation, it is assumed that light other than the reflected light from the object OJ is not received. As illustrated in FIG. 5, the frequency distribution generating unit 33 generates frequency distribution information indicating a relationship between the exposure periods “1”, “6”, and “7” in which the reflected light from the object OJ can be received and the count values of the pulse signals in the respective exposure periods. While the exposure period “1” is counted every time light is emitted, the other exposure periods “6” and “7” are counted a smaller number of times than the exposure period “1”. This is because the count of the pulse signal due to self-interference is distributed because the light emitting unit 11 emits light at the light emission interval of two patterns (the first light emission interval and the second light emission interval). That is, the light emitting unit 11 emits light at light emission intervals of two patterns of the first light emission intervals T_11 and T_13 corresponding to the length of the five exposure periods and the second light emission intervals T_12 and T_14 corresponding to the length of the six exposure periods. As a result, the count of the pulse signal due to self-interference is distributed to the two exposure periods “6” and “7”. If the light emitting unit 11 emits light at one light emission interval of one of the first light emission interval and the second light emission interval, the count of the pulse signal due to self-interference concentrates on one of the exposure period “6” and the exposure period “7”. In this case, the count value of the exposure period “6” or “7” is not different from the count value of the exposure period “1”.

In the second sub-frame period SF1_2 to the p-th sub-frame period SF1_p, the reflected light from the object OJ at the distance “1” is not received. Therefore, when the distance to the object OJ is “1”, the counts other than the distances “1”, “6”, and “7” are not generated. The peak detection unit 34 detects a peak from the frequency distribution information illustrated in FIG. 5 when the first frame period FL_1 ends, and specifies a class (exposure period “1”) corresponding to the frequency of the peak.

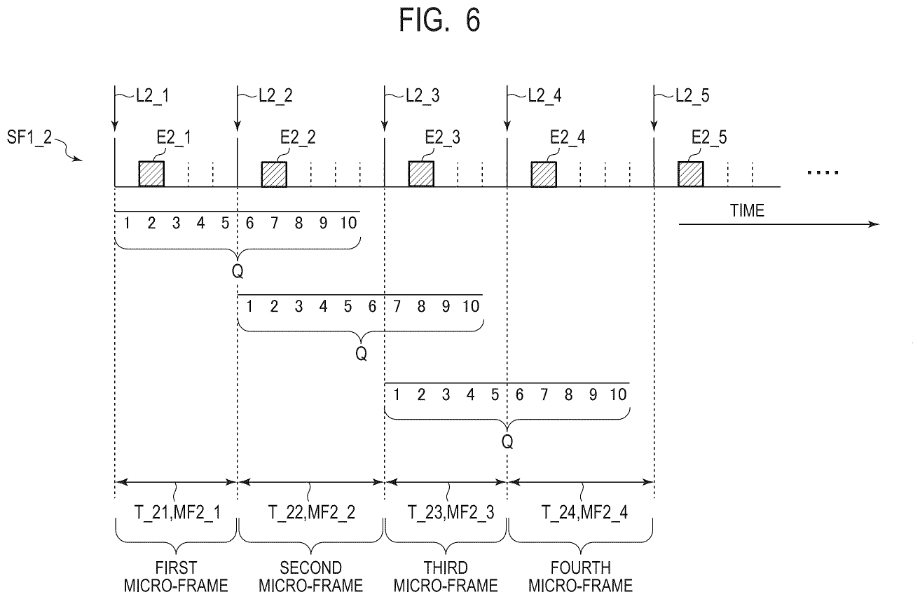

Next, an example in which the reflected light from the object OJ at the distance “2” is received in the second exposure period will be described. FIG. 6 is a timing chart illustrating a control example of a second exposure period and a light emission interval. The second sub-frame period SF1_2 illustrated in FIG. 6 is executed next to the first sub-frame period SF1_1, and is a period in which the reflected light from the object OJ at the distance “2” can be received. FIG. 6 illustrates light emission periods L2_1, L2_2, L2_3, L2_4, and L2_5, and exposure periods E2_1, E2_2, E2_3, E2_4, and E2_5. Further, micro-frame periods MF2_1, MF2_2, MF2_3, and MF2_4 are illustrated.

In the second sub-frame period SF1_2, the light emission control unit 31 outputs a light emission control signal indicating light emission in a first light emission period L2_1 to the light emitting unit 11. The light emitting unit 11 emits light in the first light emission period L2_1 based on the light emission control signal output from the light emission control unit 31. The light emission control unit 31 outputs a light emission notification indicating that the light emission control is performed in the first light emission period L2_1 to the exposure period setting unit 32.

The exposure period setting unit 32 determines a first exposure period E2_1 in the first micro-frame period MF2_1. The first exposure period E2_1 is a period in which the reflected light caused by the light emitted in the first light emission period L2_1 can be received. The first exposure period E2_1 is a period in which the reflected light from the object OJ at the distance “2” can be received. The exposure period setting unit 32 outputs an exposure control signal to the light receiving unit 21 at a start timing of the first exposure period E2_1 based on the light emission notification output from the light emission control unit 31. When the reflected light from the object OJ is incident in the first exposure period E2_1, the light receiving unit 21 converts the received light into a pulse signal, and outputs the pulse signal to the frequency distribution generating unit 33. When the reflected light is not incident, the light receiving unit 21 does not output the pulse signal to the frequency distribution generating unit 33. The exposure period setting unit 32 outputs exposure period information indicating that the first exposure period E2_1 is set in the light receiving unit 21 to the frequency distribution generating unit 33.

The frequency distribution generating unit 33 counts the pulse signal based on the pulse signal output from the light receiving unit 21 and the exposure period information (first exposure period E2_1) output from the exposure period setting unit 32. The frequency distribution generating unit 33 generates and holds frequency distribution information in which the first exposure period E2_1 is a class and a count value obtained by counting the number of pulse signals is a frequency.

In the second micro-frame period MF2_2, the light emission control unit 31 outputs a light emission control signal indicating light emission in a second light emission period L2_2 to the light emitting unit 11. The second light emission period L2_2 is determined so that a length of a light emission interval T_21 is shorter than the measurement period Q by five exposure periods as in the case of the first sub-frame period SF1_1. That is, the light emission interval T_21 is a length corresponding to five exposure periods. The light emitting unit 11 emits light in the second light emission period L2_2 based on the light emission control signal output from the light emission control unit 31. The light emission control unit 31 outputs a light emission notification indicating that the light emission control is performed in the second light emission period L2_2 to the exposure period setting unit 32.

The exposure period setting unit 32 determines a second exposure period E2_2 in the second micro-frame period MF2_2. The second exposure period E2_2 is a period in which the reflected light caused by the light emitted in the second light emission period L2_2 can be received. The second exposure period E2_2 is a period in which the reflected light from the object OJ at the distance “2” can be received. The exposure period setting unit 32 outputs an exposure control signal to the light receiving unit 21 at a start timing of the second exposure period E2_2 based on the light emission notification output from the light emission control unit 31. When the reflected light from the object OJ is incident in the second exposure period E2_2, the light receiving unit 21 converts the received light into a pulse signal and outputs the pulse signal to the frequency distribution generating unit 33. The exposure period setting unit 32 outputs exposure period information indicating that the second exposure period E2_2 is set in the light receiving unit 21 to the frequency distribution generating unit 33.

The frequency distribution generating unit 33 counts the pulse signal based on the pulse signal output from the light receiving unit 21 and the exposure period information (the second exposure period E2_2) output from the exposure period setting unit 32. The frequency distribution generating unit 33 generates and holds frequency distribution information in which the second exposure period E2_2 is a class and a count value obtained by counting the number of pulse signals is a frequency.

In the third micro-frame period MF2_3, the light emission control unit 31 outputs a light emission control signal indicating light emission in a third light emission period L2_3 to the light emitting unit 11. The third light emission period L2_3 is determined such that a length of a light emission interval T_22 from the second light emission period L2_2 to the third light emission period L2_3 is shorter than the measurement period Q and different from the length of the light emission interval T 21. The third light emission period L2_3 is determined so that the length of the light emission interval T 22 is shorter than the measurement period Q by four exposure periods as in the case of the first sub-frame period SF1_1. That is, the light emission interval T 22 is a length corresponding to six exposure periods. Thus, the light emission interval T_22 has the length different from that of the light emission interval T_21 corresponding to five exposure periods. That is, the light emission interval T_22 is longer than the light emission interval T_21 by one exposure period. The light emitting unit 11 emits light in the third light emission period L2_3 based on the light emission control signal output from the light emission control unit 31. The light emission control unit 31 outputs a light emission notification indicating that the light emission control is performed in the third light emission period L2_3 to the exposure period setting unit 32.

The exposure period setting unit 32 determines a third exposure period E2_3 in the third micro-frame period MF2_3. The third exposure period E2_3 is a period in which the reflected light caused by the light emitted in the third light emission period L2_3 can be received. The third exposure period E2_3 is a period in which the reflected light from the object OJ at the distance “2” can be received. The exposure period setting unit 32 outputs an exposure control signal to the light receiving unit 21 at a start timing of the third exposure period E2_3 based on the light emission notification output from the light emission control unit 31. When the reflected light from the object OJ is incident in the third exposure period E2_3, the light receiving unit 21 converts the received light into a pulse signal and outputs the pulse signal to the frequency distribution generating unit 33. The exposure period setting unit 32 outputs exposure period information indicating that the third exposure period E2_3 is set in the light receiving unit 21 to the frequency distribution generating unit 33.

The frequency distribution generating unit 33 counts the pulse signal based on the pulse signal output from the light receiving unit 21 and the exposure period information (third exposure period E2_3) output from the exposure period setting unit 32. The frequency distribution generating unit 33 generates and holds frequency distribution information in which the third exposure period E2_3 is a class and a count value obtained by counting the number of pulse signals is a frequency.

In the fourth micro-frame period MF2_4, the light emission control unit 31 outputs a light emission control signal indicating light emission in a fourth light emission period L2_4 to the light emitting unit 11. The fourth light emission period L2_4 is determined such that a length of a light emission interval T_23 from the third light emission period L2_3 to the fourth light emission period L2_4 is shorter than the measurement period Q and different from the length of the light emission interval T_22. The fourth light emission period L2_4 is determined such that the length of the light emission interval T_23 is shorter than the measurement period Q by five exposure periods. That is, the light emission interval T_23 is a length corresponding to five exposure periods. As described above, the light emission interval T_23 is different from the length of the light emission interval T_22, but is the same as the length of the light emission interval T_21. The light emitting unit 11 emits light in the fourth light emission period L2_4 based on the light emission control signal output from the light emission control unit 31. The light emission control unit 31 outputs a light emission notification indicating that the light emission control is performed in the fourth light emission period L2_4 to the exposure period setting unit 32.

The exposure period setting unit 32 determines a fourth exposure period E2_4 in the fourth micro-frame period. The fourth exposure period E2_4 is a period in which the reflected light caused by the light emitted in the fourth light emission period L2_4 can be received. The fourth exposure period E2_4 is a period in which the reflected light from the object OJ at the distance “2” can be received. The exposure period setting unit 32 outputs an exposure control signal to the light receiving unit 21 at a start timing of the fourth exposure period E2_4 based on the light emission notification output from the light emission control unit 31. When the reflected light from the object OJ is incident in the fourth exposure period E2_4, the light receiving unit 21 converts the received light into a pulse signal and outputs the pulse signal to the frequency distribution generating unit 33. The exposure period setting unit 32 outputs exposure period information indicating that the fourth exposure period E2_4 is set in the light receiving unit 21 to the frequency distribution generating unit 33.

The frequency distribution generating unit 33 counts the pulse signal based on the pulse signal output from the light receiving unit 21 and the exposure period information (fourth exposure period E2_4) output from the exposure period setting unit 32. The frequency distribution generating unit 33 generates and holds frequency distribution information in which the fourth exposure period E2_4 is a class and a count value obtained by counting the number of pulse signals is a frequency.

In the fifth micro-frame period (not illustrated), the light emission control unit 31 outputs a light emission control signal indicating that light is emitted in a fifth light emission period L2_5 to the light emitting unit 11. The fifth light emission period L2_5 is determined such that a length of a light emission interval T_24 from the fourth light emission period L2_4 to the fifth light emission period L2_5 is shorter than the measurement period Q and different from the length of the light emission interval T_23. The fifth light emission period L2_5 is determined such that the length of the light emission interval T_24 is shorter than the measurement period Q by four exposure periods. That is, the light emission interval T_24 is a length corresponding to six exposure periods. The light emission interval T_24 is different from the lengths of the light emission intervals T_21 and T_23, but is the same as the length of the light emission interval T_22. In this manner, the light emission control unit 31 controls the light emission intervals so that the first light emission intervals (light emission intervals T_21 and T_23) and the second light emission intervals (light emission intervals T_22 and T_24) having different lengths from the first light emission intervals alternate with each other. In this way, the light emission control unit 31 periodically changes the light emission interval. The light emitting unit 11 emits light in the fifth light emission period L2_5 based on the light emission control signal output from the light emission control unit 31. The light emission control unit 31 outputs a light emission notification indicating that the light emission control is performed in the fifth light emission period L2_5 to the exposure period setting unit 32.

The exposure period setting unit 32 determines a fifth exposure period E2_5 in the fifth micro-frame period. The fifth exposure period E2_5 is a period in which the reflected light caused by the light emitted in the fifth light emission period L2_5 can be received. The fifth exposure period E2_5 is a period in which the reflected light from the object OJ at the distance “2” can be received. The exposure period setting unit 32 outputs an exposure control signal to the light receiving unit 21 at a start timing of the fifth exposure period E2_5 based on the light emission notification output from the light emission control unit 31. When the reflected light from the object OJ is incident in the fifth exposure period E2_5, the light receiving unit 21 converts the received light into a pulse signal and outputs the pulse signal to the frequency distribution generating unit 33. The exposure period setting unit 32 outputs exposure period information indicating that the fifth exposure period E2_5 is set in the light receiving unit 21 to the frequency distribution generating unit 33.

The frequency distribution generating unit 33 counts the pulse signal based on the pulse signal output from the light receiving unit 21 and the exposure period information (fifth exposure period E2_5) output from the exposure period setting unit 32. The frequency distribution generating unit 33 generates and holds frequency distribution information in which the fifth exposure period E2_5 is a class and a count value obtained by counting the number of pulse signals is a frequency.

By setting the light emission interval T_21 to be shorter than the measurement period Q, the second exposure period E2_2 can also receive the reflected light from the object OJ at the distance “7” in the first micro-frame period MF2_1. Similarly, the third exposure period E2_3 can also receive the reflected light from the object OJ at the distance “8” in the second micro-frame period MF2_2. The fourth exposure period E2_4 can also receive reflected light from the object OJ at a distance “7” in the third micro-frame period MF2_3. The fifth exposure period E2_5 can also receive reflected light from the object OJ at a distance “8” in the fourth micro-frame period MF2_4.

In the second sub-frame period SF1_2, following the above-described fifth micro-frame period, the same processing is repeated until the q-th micro-frame period MF2_r (r is an integer of 6 or more). As described above, in the second sub-frame period SF1_2, the micro-frame period is repeated r times, and the exposure period in which the reflected light from the object OJ at the distance “2” can be received is set a plurality of times (r times). Further, in the second sub-frame period SF1_2, the light emission intervals T_21, T_22, T_23, T_24, and the like are set to be shorter than the measurement period Q. Therefore, the exposure period in which the reflected light from the object OJ at the distances “7” and “8” can be received is also set a plurality of times.

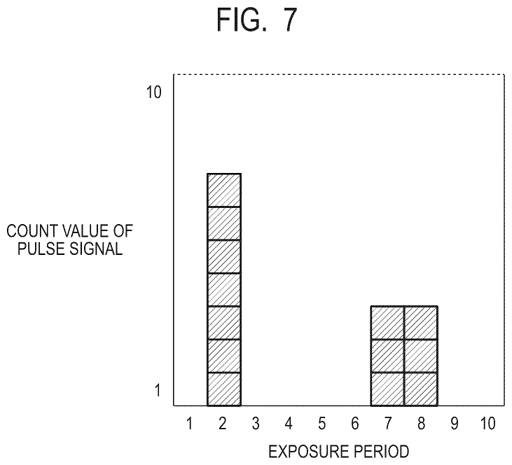

FIG. 7 is a frequency distribution illustrating the relationship between the second exposure period and the count value of the pulse signal. For convenience of explanation, it is assumed that light other than reflected light from the object OJ is not received. As illustrated in FIG. 7, the frequency distribution generating unit 33 generates frequency distribution information indicating the relationship between the exposure periods “2”, “7”, and “8” in which the reflected light from the object OJ can be received and the count values of the pulse signals in the respective exposure periods. While the exposure period “2” is counted every time light is emitted, the other exposure periods “7” and “8” are counted a smaller number of times than the exposure period “2”. This is because the count of the pulse signal due to self-interference is distributed because the light emitting unit 11 emits light at the light emission interval of two patterns (the first light emission interval and the second light emission interval). That is, the light emitting unit 11 emits light at light emission intervals of two patterns of the first light emission intervals T_21 and T_23 corresponding to the length of the five exposure periods and the second light emission intervals T_22 and T_24 corresponding to the length of the six exposure periods. As a result, the count of the pulse signal due to self-interference is distributed to two distances “7” and “8”. If the light emitting unit 11 emits light at one light emission interval of one of the first light emission interval and the second light emission interval, the count of the pulse signal due to self-interference concentrates on one of the exposure period “7” and the exposure period “8”. In this case, the count value of the exposure period “7” or “8” is not different from the count value of the exposure period “2”.

In the first sub-frame period SF1_1 and the third sub-frame period SF1_3 to the p-th sub-frame period SF1_p, the reflected light from the object OJ at the distance “2” is not received. Therefore, when the distance to the object OJ is “2”, the counts other than the exposure periods “2”, “7”, and “8” are not generated. The peak detection unit 34 detects a peak from the frequency distribution information illustrated in FIG. 7, and specifies a class (exposure period “2”) corresponding to the frequency of the peak.

As described above, the ranging device 100 according to the present embodiment includes the light emission control unit 31, the light receiving unit 21, the exposure period setting unit 32, and the frequency distribution generating unit 33. The light emission control unit 31 controls the light emitting unit 11 that emits pulse light. The light receiving unit 21 detects reflected light emitted from the light emitting unit 11 and reflected by the object OJ in the measurement target region, and converts the reflected light into a pulse signal. The exposure period setting unit 32 sets an exposure period for detecting the reflected light. The frequency distribution generating unit 33 generates frequency distribution information in which a count value obtained by counting the number of pulse signals and an exposure period are associated with each other. The light emission control unit 31 controls the light emission interval of the pulse light.

In this configuration, the light emission intervals include the first light emission interval and the second light emission interval having the length different from the length of the first light emission interval. At least one of the first light emission interval and the second light emission interval is shorter than the measurement period Q from when the pulse light is emitted to when the reflected light caused by the pulse light can be detected.

With this configuration, the ranging device 100 can suppress a decrease in frame rate by making the light emission interval shorter than the measurement period Q. In addition, the ranging device 100 includes a light emission interval having the length different from the length of another light emission interval, and thus interference with another ranging device having a constant light emission interval can be suppressed. In addition, the ranging device 100 can distribute the count of the pulse signal due to self-interference by including the light emission interval having the length different from the lengths of the other light emission intervals, and thus it is possible to suppress erroneous distance measurement due to self-interference.

In addition, according to the ranging device 100 of the present embodiment, the light emission control unit 31 controls the light emission interval so that the first light emission interval and the second light emission interval alternate with each other. With this configuration, the ranging device 100 can equally distribute the count of the pulse signal due to self-interference, and can appropriately detect the peak.

The distance measurement method according to the present embodiment includes a light emission control step, a light reception step, an exposure period setting step, and a frequency distribution generation step. In the light emission control step, the light emitting unit 11 that emits pulse light is controlled. In the light receiving step, reflected light emitted from the light emitting unit 11 and reflected by the object OJ in the measurement target region is detected and converted into a pulse signal. In the exposure period setting step, an exposure period for detecting reflected light is set. In the frequency distribution generation step, frequency distribution information in which a count value obtained by counting the number of pulse signals is associated with an exposure period is generated. In the light emission control step, a light emission interval of the pulse light is controlled. The light emission intervals include a first light emission interval and a second light emission interval having the length different from a length of the first light emission interval.

At least one of the first light emission interval and the second light emission interval is shorter than the measurement period Q from when the pulse light is emitted to when the reflected light caused by the pulse light can be detected. Thus, the ranging method can suppress interference between the ranging devices while suppressing a decrease in the frame rate.

### Second Embodiment

A ranging device 100 according to a second embodiment will be described. The present embodiment is different from the ranging device 100 according to the first embodiment in that the length of the light emission interval is randomly changed. The same components as those of the ranging device 100 according to the first embodiment are denoted by the same reference numerals, and detailed description thereof will be omitted.

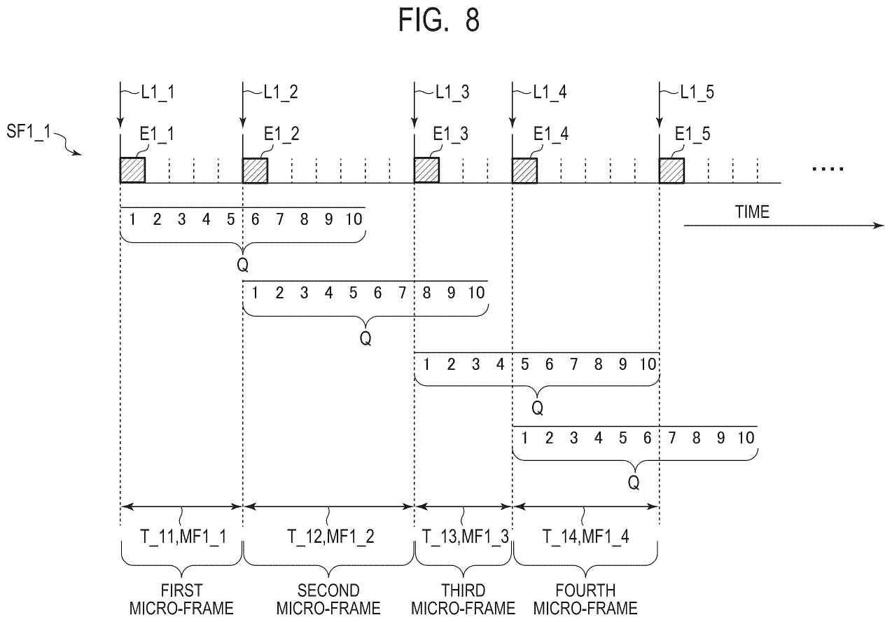

FIG. 8 is a timing chart illustrating a control example of a first exposure period and a light emission interval. FIG. 8 illustrates light emission periods L1_1, L1_2, L1_3, L1_4, and L1_5, and exposure periods E1_1, E1_2, E1_3, E1_4, and E1_5. Further, micro-frame periods MF1_1, MF1_2, MF1_3, and MF1_4 are illustrated.

In the first micro-frame period MF1_1, the light emission control unit 31 outputs a light emission control signal indicating light emission in a first light emission period L1_1 to the light emitting unit 11. In addition, the light emission control unit 31 outputs a light emission notification indicating that the light emission control is performed in the first light emission period L1_1 to the exposure period setting unit 32. The exposure period setting unit 32 outputs an exposure control signal to the light receiving unit 21 at a start timing of the first exposure period E1_1 based on the light emission notification.

In the second micro-frame period MF1_2, the light emission control unit 31 outputs a light emission control signal indicating light emission in a second light emission period L1_2 to the light emitting unit 11. The second light emission period L1_2 is determined such that a length of a light emission interval T_11 from the first light emission period L1_1 to the second light emission period L1_2 is shorter than the measurement period Q. The second light emission period L1_2 is randomly determined so that the length of the light emission interval T_11 is an integral multiple of one exposure period. Randomly determining the light emission periods means irregularly determining the light emission periods. By randomly determining the second light emission period L1_2, the length of the light emission interval T_11 is also randomly determined. The second light emission period L1_2 is determined such that the length of the light emission interval T_11 is shorter than the measurement period Q by five exposure periods. That is, the light emission interval T_11 is a length corresponding to five exposure periods. The light emission control unit 31 outputs a light emission notification indicating that the light emission control is performed in the second light emission period L1_2 to the exposure period setting unit 32. The exposure period setting unit 32 outputs an exposure control signal to the light receiving unit 21 at a start timing of the second exposure period E1_2 based on the light emission notification.

In the third micro-frame period MF1_3, the light emission control unit 31 outputs a light emission control signal indicating light emission in a third light emission period L1_3 to the light emitting unit 11. The third light emission period L1_3 is determined such that a length of the light emission interval T_12 from the second light emission period L1_2 to the third light emission period L1_3 is shorter than the measurement period Q and different from the length of the light emission interval T_11. The third light emission period L1_3 is randomly determined so that the length of the light emission interval T_12 is an integral multiple of one exposure period. By randomly determining the third light emission period L1_3, the length of the light emission interval T_12 is also irregularly determined. The third light emission period L1_3 is determined such that the length of the light emission interval T_12 is shorter than the measurement period Q by three exposure periods. That is, the light emission interval T_12 is a length corresponding to seven exposure periods. In this manner, the light emission interval T 12 has the length different from that of the light emission interval T_11. The light emission control unit 31 outputs a light emission notification indicating that the light emission control is performed in the third light emission period L1_3 to the exposure period setting unit 32. The exposure period setting unit 32 outputs an exposure control signal to the light receiving unit 21 at a start timing of the third exposure period E1_3 based on the light emission notification.

In the fourth micro-frame period MF1_4, the light emission control unit 31 outputs a light emission control signal indicating light emission in a fourth light emission period L1_4 to the light emitting unit 11. The fourth light emission period L1_4 is determined such that a length of the light emission interval T_13 from the third light emission period L1_3 to the fourth light emission period L1_4 is shorter than the measurement period Q and is different from the lengths of the light emission intervals T_11 and T_12. The fourth light emission period L1_4 is randomly determined so that the length of the light emission interval T_13 becomes an integral multiple of one exposure period. By randomly determining the fourth light emission period L1_4, the length of the light emission interval T_13 is also randomly determined. The fourth light emission period L1_4 is determined such that the length of the light emission interval T_13 is shorter than the measurement period Q by six exposure periods. That is, the light emission interval T_13 is a length corresponding to four exposure periods. Thus, the length of the light emission interval T_13 is different from the lengths of the light emission intervals T_11 and T_12. The light emission control unit 31 outputs a light emission notification indicating that the light emission control is performed in the fourth light emission period L1_4 to the exposure period setting unit 32. The exposure period setting unit 32 outputs an exposure control signal to the light receiving unit 21 at a start timing of the fourth exposure period E1_4 based on the light emission notification.

In the fifth micro-frame period (not illustrated), the light emission control unit 31 outputs a light emission control signal indicating that light is emitted in a fifth light emission period L1_5 to the light emitting unit 11. The fifth light emission period L1_5 is determined such that a length of the light emission interval T_14 from the fourth light emission period L1_4 to the fifth light emission period L1_5 is shorter than the measurement period Q and is different from the lengths of the light emission intervals T_11, T_12, and T_13. The fifth light emission period L1_5 is randomly determined so that the length of the light emission interval T_14 becomes an integral multiple of one exposure period. By randomly determining the fifth light emission period L1_5, the length of the light emission interval T_14 is also randomly determined.

The fifth light emission period L1_5 is determined such that the length of the light emission interval T_14 is shorter than the measurement period Q by four exposure periods. That is, the light emission interval T_14 is a length corresponding to six exposure periods. Thus, the length of the light emission interval T_14 is different from the lengths of the light emission intervals T_11, T_12, and T_13. The light emission control unit 31 outputs a light emission notification indicating that the light emission control is performed in the fifth light emission period L1_5 to the exposure period setting unit 32. The exposure period setting unit 32 outputs an exposure control signal to the light receiving unit 21 at a start timing of the fifth exposure period E1_5 based on the light emission notification.

By setting the light emission interval T_11 to be shorter than the measurement period Q, the second exposure period E1_2 can also receive reflected light from the object OJ at a distance “6” in the first micro-frame period MF1_1. Similarly, the third exposure period E1_3 can also receive the reflected light from the object OJ at the distance “8” in the second micro-frame period MF1_2. The fourth exposure period E1_4 can also receive reflected light from the object OJ at a distance “5” in the third micro-frame period MF1_3. The fifth exposure period E1_5 can also receive reflected light from the object OJ at a distance “7” in the fourth micro-frame period MF1_4.

In the first sub-frame period SF1_1, following the above-described fifth micro-frame period, the same processing is repeated until the q-th micro-frame period MF1_q (q is an integer of 6 or more). As described above, in the first sub-frame period SF1_1, the micro-frame period is repeated q times, and the exposure period in which the reflected light from the object OJ at the distance “1” can be received is set a plurality of times (q times). Further, in the first sub-frame period SF1_1, the light emission intervals T_11, T_12, T_13, T_14, and the like are set at random so as to be shorter than the measurement period Q. Therefore, the exposure period in which the reflected light from the object OJ can be received, such as the distances “5”, “6”, and “8”, is also set.

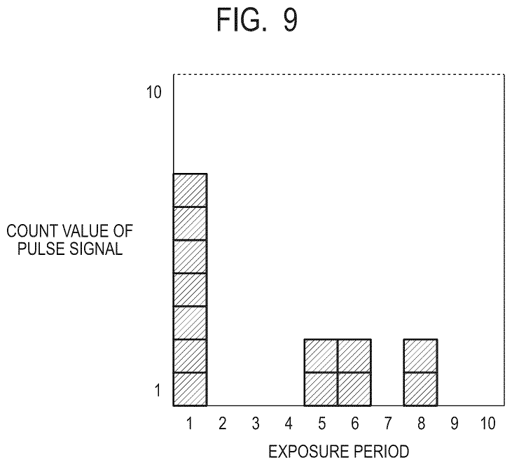

FIG. 9 is a frequency distribution illustrating the relationship between the first exposure period and the count value of the pulse signal. For convenience of explanation, it is assumed that light other than reflected light from the object OJ is not received. As illustrated in FIG. 9, the frequency distribution generating unit 33 generates frequency distribution information indicating a relationship between the exposure periods “1”, “5”, “6”, and “8” in which the reflected light from the object OJ can be received and the count values of the pulse signals in the respective exposure periods. While the exposure period “1” is counted every time light is emitted, the other exposure periods “5”, “6”, and “8” are counted a smaller number of times than the exposure period “1”. This is because the count of the pulse signal due to self-interference is distributed in the exposure periods “5”, “6”, and “8” because the light emitting unit 11 emits light at random light emission intervals. The peak detection unit 34 detects a peak from the frequency distribution information illustrated in FIG. 9, and specifies a class (exposure period “1”) corresponding to the frequency of the peak.

As described above, according to the ranging device 100 of the present embodiment, the light emission control unit 31 randomly changes the light emission interval. According to this configuration, the ranging device 100 can further increase the number of patterns of light emission intervals, and thus can further suppress interference with other ranging devices and self-interference.

### Third Embodiment

A ranging device 100 according to a third embodiment will be described. The present embodiment is different from the ranging device 100 according to the first and second embodiments in that the light emission interval is changed when a plurality of peak candidates are detected by the peak detection unit 34. The same components as those of the ranging device 100 according to the first and second embodiments are denoted by the same reference numerals, and detailed description thereof will be omitted.

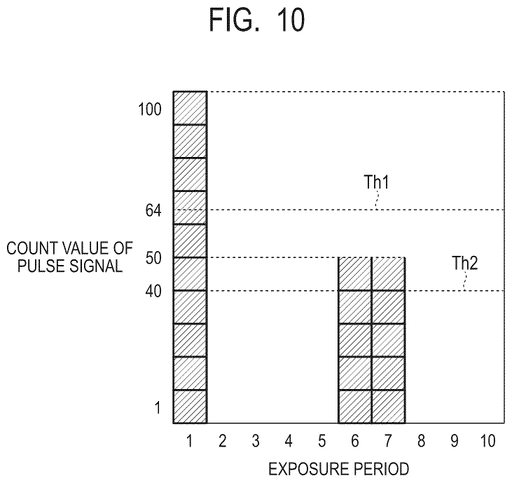

FIG. 10 is a frequency distribution illustrating a relationship between a first exposure period and a count value of a pulse signal according to a comparative example of the present embodiment. The frequency distribution information illustrated in FIG. 10 is generated by the frequency distribution generating unit 33 when the distance measurement is performed by the method illustrated in FIG. 4 in the first sub-frame period SF1_1 which is a period in which the reflected light from the object OJ at the distance “1” can be received. For convenience of explanation, it is assumed that light other than reflected light from the object OJ is not received.

As illustrated in FIG. 10, the frequency distribution generating unit 33 generates frequency distribution information indicating a relationship between the exposure periods “1”, “6”, and “7” in which the reflected light from the object OJ can be received and the count values of the pulse signals in the respective exposure periods. In the present embodiment, it is assumed that the first sub-frame period SF1_1 includes 100 micro-frame periods.

FIG. 10 illustrates a maximum value Th1 of the counter and a threshold Th2 for determining a peak in the frequency distribution information. The maximum value Th1 of the counter is “64”, and the threshold Th2 for peak determination is “40”.

The frequency distribution information illustrated in FIG. 10 is an example detected when the reflected light from the object OJ is relatively strong. When the light emitting unit 11 emits light 100 times, the reflected light from the object OJ is received 100 times in the exposure period “1” and 50 times in the exposure periods “6” and “7” by self-interference, the 50 times is half of the exposure period “1”. As a result, the count value of the pulse signal in the exposure period “1” becomes “100” and exceeds the maximum value Th1 of the counter. In addition, the count values of the pulse signals in the exposure periods “6” and “7” are “50” and are equal to or less than the maximum value Th1 of the counter. The count values of the pulse signals in the exposure periods “1”, “6”, and “7” are equal to or larger than the threshold Th2 for peak determination.

That is, there are three peak candidates detected by the peak detection unit 34. When a plurality of peak candidates are detected at the end of one sub-frame period, the peak detection unit 34 outputs a notification indicating that the number of light emission interval patterns is increased to the light emission control unit 31.

The light emission control unit 31 increases the number of light emission interval patterns based on the notification output from the peak detection unit 34. In the example illustrated in FIG. 4, the light emitting unit 11 is controlled to emit light in a pattern of two light emission intervals, that is, the first light emission intervals T_11 and T_13 corresponding to five exposure periods and the second light emission intervals T 12 and T_14 corresponding to six exposure periods. In this control, since a plurality of peak candidates are detected, the light emission control unit 31 increases the light emission interval pattern from two to three.

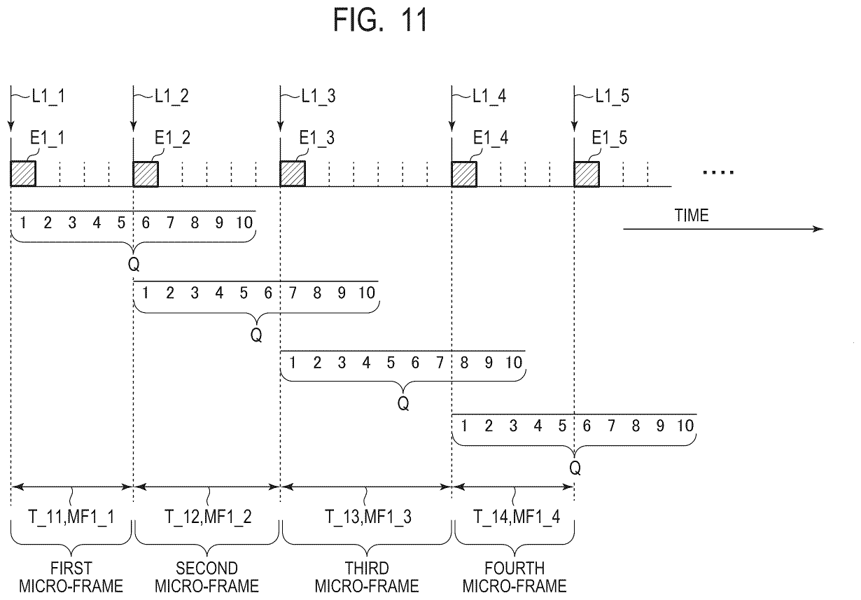

FIG. 11 is a timing chart illustrating a control example of the first exposure period and the light emission interval in the first sub-frame period SF1_1 when the pattern of the light emission interval is increased to three. FIG. 11 illustrates light emission periods L1_1, L1_2, L1_3, L1_4, and L1_5, and exposure periods E1_1, E1_2, E1_3, E1_4, and E1_5. Further, micro-frame periods MF1_1, MF1_2, MF1_3, and MF1_4 are illustrated.

In the first micro-frame period MF1_1, the light emission control unit 31 outputs a light emission control signal indicating light emission in a first light emission period L1_1 to the light emitting unit 11. The light emission control unit 31 outputs a light emission notification indicating that the light emission control is performed in the first light emission period L1_1 to the exposure period setting unit 32. The exposure period setting unit 32 outputs an exposure control signal to the light receiving unit 21 at a start timing of the first exposure period E1_1 based on the light emission notification.

In the second micro-frame period MF1_2, the light emission control unit 31 outputs a light emission control signal indicating light emission in a second light emission period L1_2 to the light emitting unit 11. The second light emission period L1_2 is determined such that the light emission interval T_11 from the first light emission period L1_1 to the second light emission period L1_2 is shorter than the measurement period Q. The second light emission period L1_2 is determined such that the light emission interval T_11 is shorter than the measurement period Q by five exposure periods. That is, the light emission interval T_11 is a length corresponding to five exposure periods. The light emission control unit 31 outputs a light emission notification indicating that the light emission control is performed in the second light emission period L1_2 to the exposure period setting unit 32. The exposure period setting unit 32 outputs an exposure control signal to the light receiving unit 21 at a start timing of the second exposure period E1_2 based on the light emission notification.

In the third micro-frame period MF1_3, the light emission control unit 31 outputs a light emission control signal indicating light emission in a third light emission period L1_3 to the light emitting unit 11. The third light emission period L1_3 is determined such that a length of the light emission interval T_12 from the second light emission period L1_2 to the third light emission period L1_3 is shorter than the measurement period Q and different from the length of the light emission interval T_11. The third light emission period L1_3 is determined such that the length of the light emission interval T_12 is shorter than the measurement period Q by four exposure periods. That is, the light emission interval T_12 is a length corresponding to six exposure periods. As described above, the light emission interval T_12 has the length different from that of the light emission interval T_11 corresponding to five exposure periods. That is, the light emission interval T_12 is longer than the light emission interval T_11 by one exposure period. The light emission control unit 31 outputs a light emission notification indicating that the light emission control is performed in the third light emission period L1_3 to the exposure period setting unit 32. The exposure period setting unit 32 outputs an exposure control signal to the light receiving unit 21 at a start timing of the third exposure period E1_3 based on the light emission notification.

In the fourth micro-frame period MF1_4, the light emission control unit 31 outputs a light emission control signal indicating light emission in a fourth light emission period L1_4 to the light emitting unit 11. The fourth light emission period L1_4 is determined such that a length of the light emission interval T_13 from the third light emission period L1_3 to the fourth light emission period L1_4 is shorter than the measurement period Q and is different from the lengths of the light emission intervals T_11 and T_12. The fourth light emission period L1_4 is determined such that the length of the light emission interval T_13 is shorter than the measurement period Q by three exposure periods. That is, the light emission interval T_13 is a length corresponding to seven exposure periods. Thus, the light emission interval T_13 is different from the lengths of the light emission intervals T_11 and T_12. The light emission control unit 31 outputs a light emission notification indicating that the light emission control is performed in the fourth light emission period L1_4 to the exposure period setting unit 32. The exposure period setting unit 32 outputs an exposure control signal to the light receiving unit 21 at a start timing of the fourth exposure period E1_4 based on the light emission notification.

In the fifth micro-frame period (not illustrated), the light emission control unit 31 outputs a light emission control signal indicating that light is emitted in a fifth light emission period L1_5 to the light emitting unit 11. The fifth light emission period L1_5 is determined such that a length of the light emission interval T_14 from the fourth light emission period L1_4 to the fifth light emission period L1_5 is shorter than the measurement period Q and is different from the lengths of the light emission intervals T_12 and T_13. The fifth light emission period L1_5 is determined such that the length of the light emission interval T_14 is shorter than the measurement period Q by five exposure periods. That is, the light emission interval T_14 is a length corresponding to five exposure periods. As described above, the light emission interval T_14 is different from the lengths of the light emission intervals T_12 and T_13, but is the same as the length of the light emission interval T_11. The light emission control unit 31 outputs a light emission notification indicating that the light emission control is performed in the fifth light emission period L1_5 to the exposure period setting unit 32. The exposure period setting unit 32 outputs an exposure control signal to the light receiving unit 21 at a start timing of the fifth exposure period E1_5 based on the light emission notification.

By setting the light emission interval T_11 to be shorter than the measurement period Q, the second exposure period E1_2 can also receive reflected light from the object OJ at a distance “6” in the first micro-frame period MF1_1. Similarly, the third exposure period E1_3 can also receive the reflected light from the object OJ at the distance “7” in the second micro-frame period MF1_2. The fourth exposure period E1_4 can also receive reflected light from the object OJ at a distance “8” in the third micro-frame period MF1_3. The fifth exposure period E1_5 can also receive reflected light from the object OJ at a distance “6” in the fourth micro-frame period MF1_4.

In the first sub-frame period SF1_1, following the above-described fifth micro-frame period, the same processing is repeated until the q-th micro-frame period MF1_q (q is an integer of 6 or more). As described above, in the first sub-frame period SF1_1, the micro-frame period is repeated q times, and the exposure period in which the reflected light from the object OJ at the distance “1” can be received is set a plurality of times (q times). Further, in the first sub-frame period SF1_1, the light emission intervals T_11, T_12, T_13, T_14, and the like are set to be shorter than the measurement period Q. Therefore, the exposure period in which the reflected light from the object OJ at the distances “6”, “7”, and “8” can be received is also set a plurality of times.

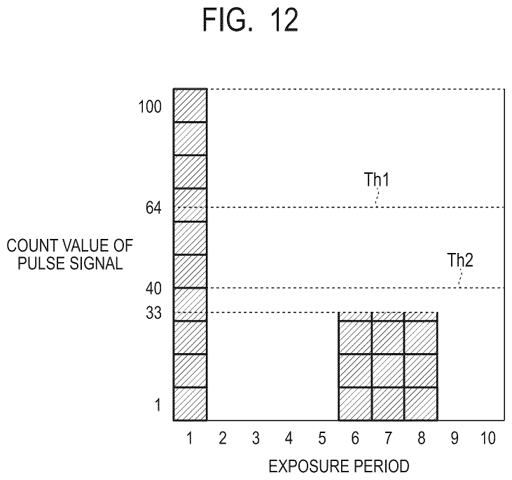

In the present embodiment, the number of patterns of light emission intervals is increased from two to three. That is, the number of patterns is increased to three patterns which are the light emission intervals T_11 and T_14 corresponding to five exposure periods, the light emission interval T_12 corresponding to six exposure periods, and the light emission interval T_13 corresponding to seven exposure periods. Thereby, as illustrated in FIG. 12, in addition to receiving the reflected light from the object OJ in the exposure period “1”, the reflected light from the object OJ is received in the exposure periods “6”, “7”, and “8”. When the light emitting unit 11 emits light 100 times, the reflected light from the object OJ is received 100 times in the exposure period “1” and received 33 times in the exposure periods “6”, “7”, and “8”, the 33 times is about ⅓ of the 100 times. In this way, the exposure periods counted by self-interference are increased from two to three, the count value of the pulse signal can be more distributed. As a result, the count value of the pulse signal in the exposure period “1” becomes equal to or larger than the threshold Th2 for peak determination. The count values of the pulse signals in the exposure periods “6”, “7”, and “8” are less than the threshold Th2 for peak determination. There is only one peak in the frequency distribution information. Accordingly, the peak detection unit 34 can appropriately specify the class (exposure period “1”) corresponding to the frequency of the peak.

As described above, according to the ranging device 100 of the present embodiment, the first light emission interval T_11 and the second light emission interval T_12 are consecutive. The exposure period E1_1 in the first light emission interval T_11 and the exposure period E1_2 in the second light emission interval T_12 are included in one measurement period Q. When a plurality of exposure periods are included in such a measurement period Q, the peak detection unit 34 detects a count value obtained by counting the number of pulse signals as a candidate for a peak when the count value is equal to or greater than the threshold Th2. When a plurality of peak candidates are detected, the peak detection unit 34 outputs a notification indicating that the number of light emission interval patterns is increased to the light emission control unit 31. The light emission control unit 31 increases the number of light emission interval patterns based on the notification output from the peak detection unit 34.

After increasing the number of light emission interval patterns, the light emission control unit 31 controls the light emitting unit 11 based on the increased light emission interval pattern. In this way, the light emission control unit 31 changes the light emission interval based on the comparison result between the count value of the pulse signal and the Th2 threshold value. With this configuration, when a plurality of peak candidates are detected, the ranging device 100 can further distribute the exposure periods counted by self-interference. Accordingly, the ranging device 100 can reduce the count value of the exposure period counted by the self-interference. As a result, even when a plurality of peak candidates are detected when the reflected light from the object OJ is relatively strong, the ranging device 100 can appropriately detect the peaks.

### Fourth Embodiment

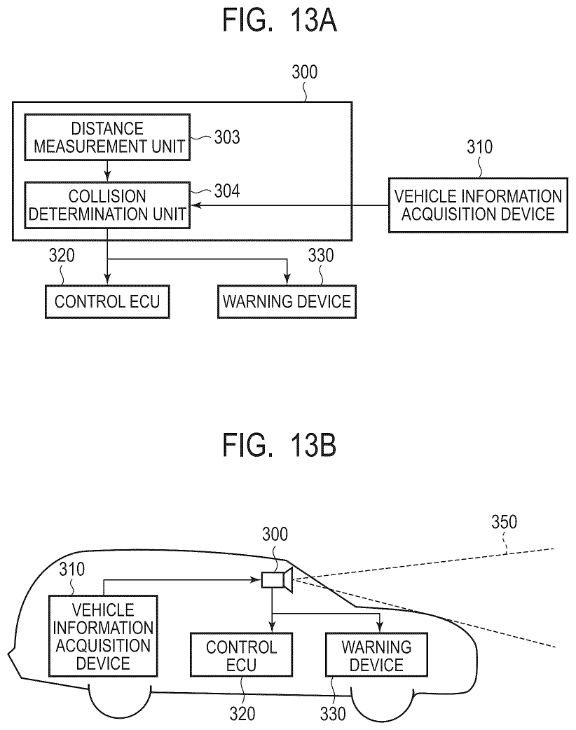

Next, movable body according to the fourth embodiment will be described with reference to FIGS. 13A and 13B. FIGS. 13A and 13B are diagrams illustrating a configuration example of a movable body according to the fourth embodiment.

FIG. 13A illustrates a configuration example of a device mounted on a vehicle as an in-vehicle camera. The device 300 includes a distance measurement unit 303 that measures a distance to an object, and a collision determination unit 304 that determines whether there is a possibility of collision based on the distance measured by the distance measurement unit 303. The distance measurement unit 303 is configured by the ranging device 100 described in the first to third embodiments. The distance measurement unit 303 is an example of a distance information acquisition unit that acquires distance information to the object. That is, the distance information is information related to a distance to the object or the like.

The device 300 is connected to the vehicle information acquisition device 310, and can acquire vehicle information such as a vehicle speed, a yaw rate, and a steering angle. In addition, a control ECU 320, which is a control device that outputs a control signal for generating a braking force to the vehicle based on the determination result of the collision determination unit 304, is connected to the device 300. The device 300 is also connected to a warning device 330 that issues a warning to the driver based on the determination result of the collision determination unit 304. For example, when the determination result of the collision determination unit 304 indicates that the possibility of collision is high, the control ECU 320 performs vehicle control to avoid collision and reduce damage by applying a brake, returning an accelerator, suppressing engine output, or the like. The warning device 330 gives a warning to the user by sounding a warning such as a sound, displaying warning information on a screen of a car navigation system or the like, giving vibration to a seat belt or a steering wheel, or the like. These devices of the device 300 function as a movable body control unit that controls the operation of controlling the vehicle as described above.

In the present embodiment, the distance to the surroundings of the vehicle, for example, the front or the rear is measured by the device 300. FIG. 13B illustrates a device in the case of distance measurement in front of the vehicle (distance measurement range 350). The vehicle information acquisition device 310 serving as the distance measurement control unit sends an instruction to the device 300 or the distance measurement unit 303 to perform the distance measurement operation. With such a configuration, the accuracy of distance measurement can be further improved.

In the above description, an example in which control is performed so as not to collide with another vehicle has been described, but the present invention is also applicable to control in which automatic driving is performed so as to follow another vehicle, control in which automatic driving is performed so as not to protrude from a lane, and the like. Furthermore, the device is not limited to vehicles such as automobiles, and can be applied to, for example, ships, aircrafts, artificial satellites, industrial robots, consumer robots, and the like movable body (mobile devices). In addition, the present invention is not limited to movable body, and can be widely applied to devices utilizing object recognition or biological recognition, such as an intelligent traffic system (ITS) and a monitoring system.

### MODIFIED EMBODIMENTS

The present disclosure is not limited to the above embodiment, and various modifications are possible. For example, an example in which a part of the configuration of any of the embodiments is added to another embodiment or an example in which a part of the configuration of another embodiment is replaced with another embodiment is also an embodiment of the present disclosure.

For example, in the present embodiment, an example has been described in which measurement is performed for the same exposure period in one sub-frame, but measurement may be performed for a plurality of different exposure periods. The light emission interval is not limited to the light emission intervals illustrated in FIGS. 4 and 6, and other light emission intervals may be used.

The light emission intervals may include the first light emission interval, the second light emission interval following the first light emission interval, and the third light emission interval following the second light emission interval. In this case, the light emission control unit 31 may control the light emission interval so that the difference between the second light emission interval and the third light emission interval is larger than the difference between the first light emission interval and the second light emission interval. In addition, the light emission control unit 31 may control the light emission interval so that the difference between the second light emission interval and the third light emission interval is smaller than the difference between the first light emission interval and the second light emission interval.

In addition, although an example in which all of the light emission intervals are shorter than the measurement period Q has been described, the present invention is not limited thereto. For example, the light emission intervals may include both a light emission interval shorter than the measurement period Q and a light emission interval longer than the measurement period Q. That is, at least one of the light emission intervals may be longer than the measurement period Q. In this case, the exposure periods may not be included in one measurement period.

In addition, although an example in which the light emission control unit 31 changes the light emission interval based on the comparison result between the count value and the threshold Th2 has been described, the present disclosure is not limited thereto, and for example, the light emission interval may be changed based on a frequency distribution of the count value.

In addition, the pattern of the light emission interval is increased when the peaks are detected when one sub-frame period ends, the present invention is not limited thereto. For example, in a case where a plurality of peak candidates are detected in the middle of one sub-frame period, the light emission control unit 31 may shift to the next sub-frame period after increasing the number of light emission interval patterns without performing processing in the middle of the sub-frame period and thereafter. In this case, the frequency distribution generating unit 33 stops the generation of the frequency distribution information, and starts the generation of the frequency distribution information after the light emission interval is changed. Accordingly, it is possible to suppress a decrease in the processing speed.

In addition, although an example in which the measurement period Q is divided into ten exposure periods “1” to “10” has been described, the present invention is not limited thereto, and the measurement period Q may be divided into other times.

Although the ranging device has been described in the above embodiment, the algorithm described in the above embodiment can also be applied to an information processing device for processing distance data indicating a distance to the object. In this case, in the configuration of the ranging device 100 illustrated in FIG. 2, the light emission control unit 31, the exposure period setting unit 32, the frequency distribution generating unit 33, the peak detection unit 34, and the output unit 35 may be configured by an information processing device. The information processing device may be a device such as a personal computer including a processor (for example, a CPU or an MPU). Alternatively, the information processing device may be a circuit such as an ASIC that realizes the functions of the exposure period setting unit 32, the light emission control unit 31, the exposure period setting unit 32, the frequency distribution generating unit 33, the peak detection unit 34, and the output unit 35.

In addition, although an example in which the function of calculating the distance to the object OJ is included in the external device has been described, the function is not limited thereto, and for example, the ranging device 100 may include the function.

The distance measurement method, wherein at least one of the first light emission interval and the second light emission interval is shorter than a measurement period from when the pulse light is emitted to when the reflected light caused by the pulse light can be detected.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-021247, filed Feb. 15, 2024, which is hereby incorporated by reference herein in its entirety.

What is claimed is:

1. A ranging device comprising:
a light emission control unit configured to control a light emitting unit that emits a pulse light;
a light receiving unit configured to detect reflected light emitted from the light emitting unit and reflected by an object in a measurement target region and convert the reflected light into a pulse signal;
an exposure period setting unit configured to set an exposure period for detecting the reflected light; and
a frequency distribution generating unit configured to generate frequency distribution information in which a count value obtained by counting the number of pulse signals and the exposure period are associated with each other,
wherein the light emission control unit controls a light emission interval of the pulse light,
wherein a plurality of light emission intervals include a first light emission interval and a second light emission interval having a length different from a length of the first light emission interval,
wherein at least one of the first light emission interval and the second light emission interval is shorter than a measurement period from when the pulse light is emitted to when the reflected light caused by the pulse light can be detected.

2. The ranging device according to claim 1,
wherein the first light emission interval and the second light emission interval are consecutive,
wherein the exposure period in the first light emission interval and the exposure period in the second light emission interval are included in the one measurement period.

3. The ranging device according to claim 1, wherein the light emission control unit controls the light emission interval so that the first light emission interval and the second light emission interval alternate with each other.

4. The ranging device according to claim 1, wherein a difference between the first light emission interval and the second light emission interval corresponds to an integral multiple of the exposure period.

5. The ranging device according to claim 1, wherein the light emission control unit randomly changes the light emission interval.

6. The ranging device according to claim 1, wherein the light emission control unit periodically changes the light emission interval.

7. The ranging device according to claim 1,
wherein the plurality of light emission intervals include a third light emission interval subsequent to the second light emission interval,
wherein the light emission control unit controls the light emission interval such that a difference between the second light emission interval and the third light emission interval is greater than a difference between the first light emission interval and the second light emission interval.

8. The ranging device according to claim 1,
wherein the plurality of light emission intervals include a third light emission interval subsequent to the second light emission interval,
wherein the light emission control unit controls the light emission interval such that a difference between the second light emission interval and the third light emission interval is smaller than a difference between the first light emission interval and the second light emission interval.

9. The ranging device according to claim 1, wherein when a plurality of peak candidates of the count value are detected, the light emission control unit changes the light emission interval.

10. The ranging device according to claim 1, wherein the light emission control unit changes the light emission interval based on a comparison result between the count value and a predetermined threshold value.

11. The ranging device according to claim 1, wherein the light emission control unit changes the light emission interval based on a frequency distribution of the count value.

12. The ranging device according to claim 1, wherein when a plurality of peak candidates of the count value are detected, the frequency distribution generating unit stops generation of the frequency distribution information, and starts generation of the frequency distribution information after the light emission interval is changed.

13. The ranging device according to claim 1, wherein at least one of the plurality of light emission intervals is longer than the measurement period.

14. A movable body comprising:
the ranging device according to claim 1; and
a control unit configured to control the movable body based on distance information acquired by the ranging device.

15. A ranging method comprising:
controlling a light emitting unit that emits a pulse light;
detecting reflected light emitted from the light emitting unit and reflected by an object in a measurement target region and converting the reflected light into a pulse signal,
setting an exposure period for detecting the reflected light; and
generating frequency distribution information in which a count value obtained by counting the number of pulse signals and the exposure period are associated with each other,
wherein in the controlling, a light emission interval of the pulse light is controlled,
wherein a plurality of light emission intervals include a first light emission interval and a second light emission interval having a length different from a length of the first light emission interval, and
wherein at least one of the first light emission interval and the second light emission interval is shorter than a measurement period from when the pulse light is emitted to when the reflected light caused by the pulse light can be detected.
